(19) United States
(12) Patent Application Publication
(10) Pub. No.: US 2004/0076074 A1
(43) Pub. Date: Apr. 22, 2004

(54) Combination container, dispenser, and stirrer

(76) Inventor: Daniel W. Shubeck, La Selva Beach, CA (US)

Correspondence Address: Jeffrey Hall, 212 Clinton Street, Santa Cruz, CA, 95062, US

(21) Appl. No.: 10/271,698

(22) Filed: Oct. 16, 2002

(51) Int. Cl. B01F 13/00

(52) U.S. Cl. 366/129

(57) ABSTRACT

A combination condiment container, dispenser, and stirrer, comprising a tubular element having an outer curved portion and a hollow core portion, a first end portion and a second end portion, and a first side portion and a second side portion. A stirring element is attached to the tubular element, and may be wing shaped, oval, round, rectangular, or other geometric or artistic configuration. A cap may be provided at the first and second end portions of the tubular element.

### BACKGROUND OF THE INVENTION

### 37 C.F.R. 1.77(a)-(7)

1. Technical Field

This invention relates to stirring implements, and in particular to a stirring implement which is a combination condiment container, dispenser, and stirrer.

2. Background Art

The usefulness of straws and other stirrers are well known and have been used for a number of years. Straws and other tubular implements have been used to for drinking, stirring, mixing and the like.

Heretofore, although straws and other stirring implements have been proposed and implemented, such devices are typically limited in function. The present invention provides a combination container, dispenser, stirrer, extraction device and straw, which is easy to use, efficient, environmentally benign, and is far less expensive than the components and functionality's provided individually.

Accordingly, it is the primary object of this invention to provide a combination condiment container, dispenser, and stirrer. The present invention may be provided in a number of sizes and configurations, and used to display logos, trademarks, or other design insignia if desired.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims

### BRIEF SUMMARY OF THE INVENTION

### 37 C.F.R. 1.77(a)(8)

To achieve the foregoing objects, and in accordance with the purpose of the invention as embodied and broadly described herein, a combination condiment container, dispenser, and stirrer, is provided comprising a tubular element having an outer curved portion and a hollow core portion, a first end portion and a second end portion, and a first side portion and a second side portion. A stirring element is attached to the tubular element, and may be wing shaped, oval, round, rectangular, or other geometric or artistic configuration. A cap may be provided at the first and second end portions of the tubular element.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a sectional view of a combination condiment container, dispenser, and stirrer, according to the invention.

FIG. 2 is a side view of such combination condiment container, dispenser, and stirrer according to the invention.

FIG. 3 shows an embodiment of such a device with a stirrer having an artistic design or logo, according to the invention.

FIG. 4, shows an embodiment of such a device with a stirrer having a rectangular shaped stirrer, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the present invention, there is provided in a preferred embodiment of the invention, a combination condiment container, dispenser, and stirrer, comprising a tubular element having an outer curved portion and a hollow core portion, a first end portion and a second end portion, and a first side portion and a second side portion. A stirring element is attached to the tubular element, and may be wing shaped, oval, round, rectangular, or other geometric or artistic configuration. A cap may be provided at the first and second end portions of the tubular element.

In FIG. 1, a combination condiment container, dispenser, and stirrer 10, is shown, with a tubular element 12, preferably configured as a straw. Tubular element 12, has an outer curved portion 14, and a hollow core portion 16, a first end portion 18, a second end portion 20, and a first side portion 22, and a second side portion 24, Condiments 13, may be placed in hollow core portion 16, if desired.

Tubular element 12, is preferably composed of a durable, resilient material, such as plastic, and may be provided in any size desired.

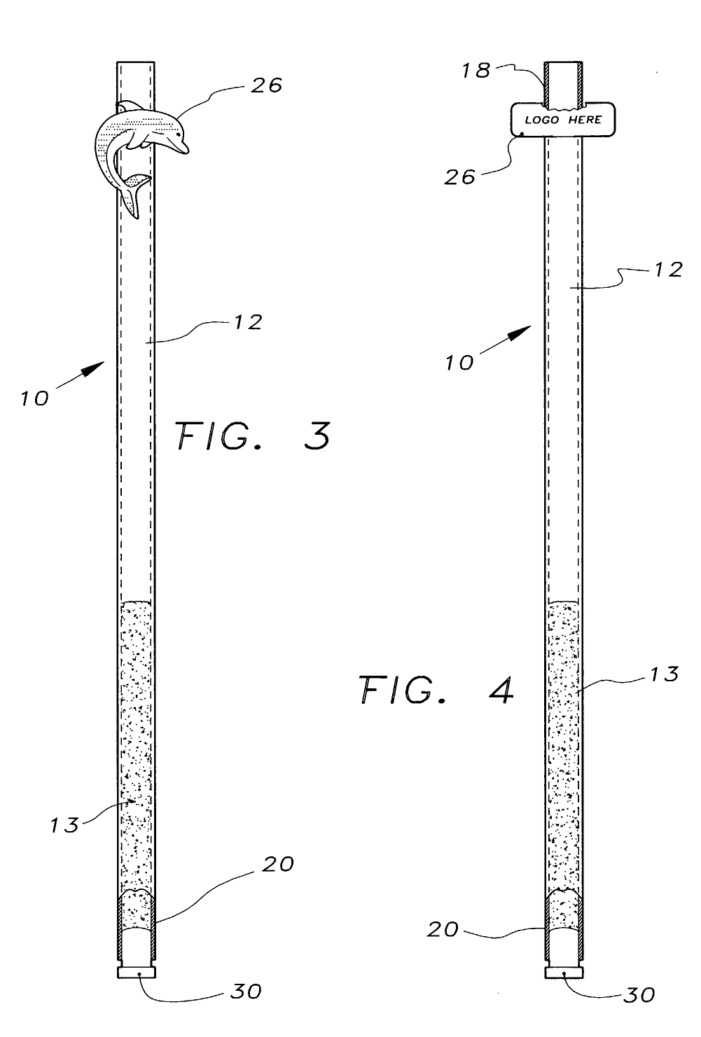

As seen in FIGS. 1-4, a stirring element 26, is attached to tubular element 12. Stirring element 26, may be provided in any shape desired, such as the wing shaped configuration shown in FIG. 1, or an oval, round, rectangular, square, or other geometric configuration. Stirring element 26, may also be provided in any artistic shape or configuration, or logo, such as seen in FIG. 3, for example. In FIG. 4, a rectangular shaped stirrer 26, is shown, which may, for example, have a trademark or logo placed thereon.

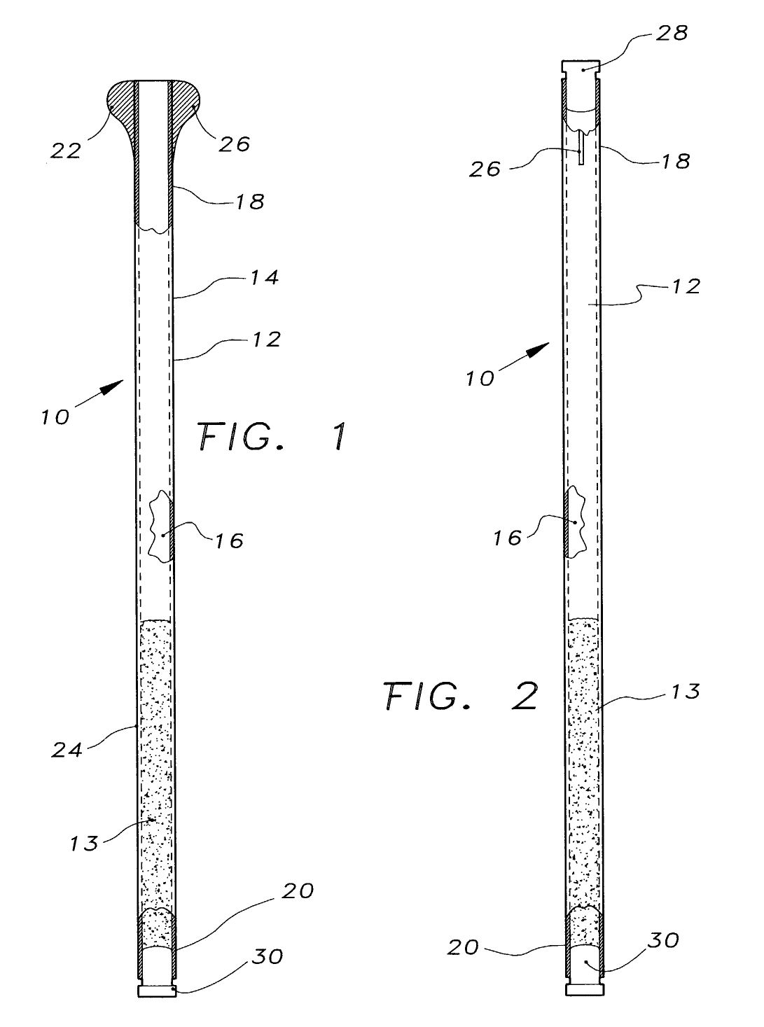

In FIGS. 1 and 2, a cap 28, is seen at first end portion 18, of tubular element 12. Cap 28, is used to seal and cover the opening of core portion 16, at end portion 18, of tubular element 12. Another cap 30, may be used at second end portion of tubular element 12 to seal and cover the opening of core portion 16, at end portion 20, of tubular element 12. The use of caps 28 and 30, are for holding condiments in tubular element 12, and are designed for easy placement and removal.

The combination condiment container, dispenser, and stirrer 10, may in different embodiments, have stirring element 26, positioned on first side portion 22, or on second side portion 24, or on both sides as seen in FIG. 1. Stirring element 26, may be formed as part of and integral with tubular element 12, or adhered with adhesives, or fitted by a slot, groove, or ring type fasteners to tubular element 12.

In operation and use, combination condiment container, dispenser, and stirrer 10, is very convenient, environmentally harmless, inexpensive, effective, and saves time at containing, stirring and dispensing condiments, spices, medications, fluids, and the like. If condiments, for example a sweetener for coffee or tea, or other drink, is stored in tubular element 12, the user would simply remove cap 30, release the sweetener into the drink, and remove cap 28, and proceed to drink through tubular element 12. Of course, a wide variety of condiments may be stored in tubular element 12, such as sugar, various artificial sweeteners, coffee, cream, and the like. Similarly, a wide variety of condiments and drinks may be consumed through tubular element 12, which like a straw, may be easily and conveniently used.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A combination condiment container, dispenser, and stirrer, comprising:
a tubular element, said tubular element having an outer curved portion and a hollow core portion, a first end portion and a second end portion, a first side portion and a second side portion; and
a stirring element attached to said tubular element.

2. The combination condiment container, dispenser, and stirrer of claim 1, further including a cap at said first end portion of said tubular element.

3. The combination condiment container, dispenser, and stirrer of claim 1, further including a cap at said second end portion of said tubular element.

4. The combination condiment container, dispenser, and stirrer of claim 1, wherein said stirring element is positioned on said first side portion of said tubular element.

5. The combination condiment container, dispenser, and stirrer of claim 1, wherein said stirring element is positioned on said first side portion and said second side portion of said tubular element.

6. The combination condiment container, dispenser, and stirrer of claim 1, wherein said stirring element is wing shaped.

7. The combination condiment container, dispenser, and stirrer of claim 1, wherein said stirring element is oval.

8. The combination condiment container, dispenser, and stirrer of claim 1, wherein said stirring element is rectangular.

9. The combination condiment container, dispenser, and stirrer of claim 1, wherein said stirring element is round.

10. The combination condiment container, dispenser, and stirrer of claim 1, wherein said stirring element is a logo or artistic design.
